(19) United States
(12) Patent Application Publication
(10) Pub. No.: US 2026/0220804 A1
(43) Pub. Date: Jul. 30, 2026

(54) GENERALIZABLE MULTI-VIEW STEREO DEPTH ESTIMATION MODEL

(71) Applicant: Niantic Spatial, Inc., San Francisco, CA (US)

(72) Inventors: Sergio Izquierdo, Zaragoza (ES); Mohamed Amr Abdelfattah Sayed, London (GB); Michael David Firman, Bristol (GB); Guillermo Garcia-Hernando, London (GB); Daniyar Turmukhambetov, London (GB); Oisin Mac Aodha, Edinburgh (GB); Gabriel J. Brostow, Bristol (GB); James Watson, London (GB)

(21) Appl. No.: 19/462,340

(22) Filed: Jan. 28, 2026

Related U.S. Application Data
(60) Provisional application No. 63/760,586, filed on Feb. 19, 2025.
(60) Provisional application No. 63/751,125, filed on Jan. 29, 2025.

(51) Int. Cl. G06T 7/593; G06T 7/73

(52) U.S. Cl. CPC G06T 7/593; G06T 7/74; G06T 2207/20084

(57) ABSTRACT

A system receives a set of images of a scene, each captured from a different viewpoint, including a designated reference image and multiple source images. For each image, a deep feature model generates a feature map that encodes visual patterns and structures. The system constructs a cost volume by mapping source image features into the reference frame and comparing feature values across a range of discrete depth bins. This cost volume is divided into spatial patches, each of which is concatenated with corresponding monocular features extracted from the reference image. The combined patches are transformed into a sequence of tokens using strided convolutions. These tokens are processed by a transformer neural network, which aggregates information to predict per-pixel depth values for the reference image. The resulting depth map provides a detailed representation of scene geometry, supporting robust and generalizable 3D reconstruction across diverse environments and input configurations.

### CROSS-REFERENCE TO RELATED APPLICATIONS

This application claims the benefit of U.S. Provisional Patent Application No. 63/751,125, filed January 29, 2025, and U.S. Provisional Patent Application No. 63/760,586, filed February 19, 2025, and each of which are incorporated by reference.

### BACKGROUND

### 1. Technical Field

The subject matter described relates generally to image depth prediction, and, in particular, to a depth-prediction model that can be applied to multiple domains.

### 2. Problem

Estimating accurate depth from multiple images may be used in various three-dimensional (3D) vision tasks, such as 3D reconstruction of an imaged environment. Although Multi-View Stereo (MVS) methods have revolutionized the field of 3D reconstruction and have numerous applications, existing methods typically struggle to generalize to scene and camera setups that differ significantly from those of images used for their training data.

Earlier MVS methods were traditionally both trained and tested on the same dataset/domain and were limited in their ability to generalize to out of distribution data. However, a model over-tuned to one domain is less useful for practitioners who wish to infer depths on their own data without additional training. And approaches such as a training on synthetic or pseudo-labeled depth struggle to span a diverse range of scene types and scales. Though self-supervised approaches can be trained without depth supervision, such approaches currently produce inferior depths compared to fully supervised approaches. As a result, there is a pressing need for multi-domain (e.g., general purpose) MVS methods that are more robust to differences between the training methods and test distributions.

### SUMMARY

A computing system estimates the depth of objects in a scene using a set of images captured from different viewpoints. The system may receive a collection of images that are each taken from a unique perspective. For example, the set of images may be frames from a video or photographs snapped from various angles around an object or environment. The system selects one image as the reference image while the others serve as source images. Each image may be associated with camera parameters, such as position, orientation, and internal settings.

For each image in the set, the system applies a deep feature model, such as a convolutional neural network or a vision transformer, to generate a deep feature map. These feature maps may be multi-dimensional arrays that encode complex visual information, capturing patterns, textures, edges, and higher-level structures within the images. Deep feature maps may provide a rich, abstract representation of the scene, enabling the system to recognize and compare subtle visual cues across different images.

The computing system constructs a cost volume, which is a three-dimensional array that quantifies how well different hypothetical depths represent features of the set of images. To generate the cost volume, the computing system determines a plausible range of depths from the camera to points in the scene using the camera parameters and the geometry of the environment. This range is divided into discrete intervals, or “bins,” which may be spaced linearly or logarithmically, depending on the expected distribution of depths in the scene.

For each depth bin, the system “warps” the deep feature maps from each source image into the viewpoint of the reference image. Warping, in this context, means projecting a pixel from the reference image into three-dimensional space at a certain depth, then using the known camera positions to determine where that 3D point would appear in the reference frame of each source image. This process aligns the features from the source images to the reference image’s viewpoint for each depth hypothesis, enabling direct comparison.

For each pixel in the reference image and each depth bin, the system compares the feature at that location with the corresponding feature in the warped source image. The result is a “cost score” that quantifies the similarity (or dissimilarity) between the features. Additional metadata, such as ray directions, angles, and validity masks, may be included to improve accuracy and robustness. The cost scores for all pixels and all depth bins form the cost volume, which encodes how well each depth hypothesis explains the observed images.

Because the cost volume is typically very large, the system divides it into smaller, manageable “patches.” Each patch is a local region of the cost volume, covering a subset of the image and the full range of depth bins. The system extracts monocular features from the reference image, which may be features that suggest depth from a single image, such as texture gradients, object boundaries, and learned patterns. The monocular features may be extracted from the deep feature map of the reference image or may be generated by applying an image encoder to the reference image. The system concatenates each of the patches with the corresponding monocular features from the reference image. This concatenation ensures that each patch contains both multi-view geometric information and single-image depth cues.

The concatenated patches are then converted into a sequence of “tokens” using a set of convolutions, often with a stride greater than one to downsample the data. Each token may represent a local region of the scene, containing both multi-view and monocular information. This sequence of tokens is fed into a transformer model, which outputs a sequence of refined tokens. The decoder network may progressively upsample and processes the tokens to construct a depth map at the original resolution of the reference image. The final output is a per-pixel depth prediction for the reference image, representing the estimated distance from the camera to every point in the scene. The depth map is then stored for further use, such as 3D reconstruction, navigation, or visualization.

Unlike traditional systems that require fixed numbers of input images or known depth ranges, this system is designed to be flexible and robust. The system uses a view-count-agnostic cost volume construction which allows any number of images to be used, and it can generalize to scenes with widely varying depth ranges by estimating the valid depth range from camera geometry and refining its predictions iteratively. Additionally, by fusing monocular and multi-view cues at multiple levels, the system is robust to challenging scenarios such as limited image overlap or ambiguous visual features. This flexibility means the system can work in many different environments (e.g., indoors, outdoors, close-up, or far away) without needing to be retrained or manually adjusted.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for generalized depth prediction, according to one embodiment.

FIG. 4 illustrates an example process for generating cost scores based on deep feature maps, in accordance with some embodiments.

FIG. 5 illustrates an example process for generating a token sequence for input to a transformer model based on a set of source images, in accordance with some embodiments.

FIG. 6 is a block diagram of an example computer suitable for use as a client device or game server.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where determining depth information from images is desirable. In addition, the inherent flexibility of computer-based systems allows for a great variety of possible configurations, combinations, and divisions of tasks and functionality between and among the components of the system.

### Example Location-Based Parallel Reality Game

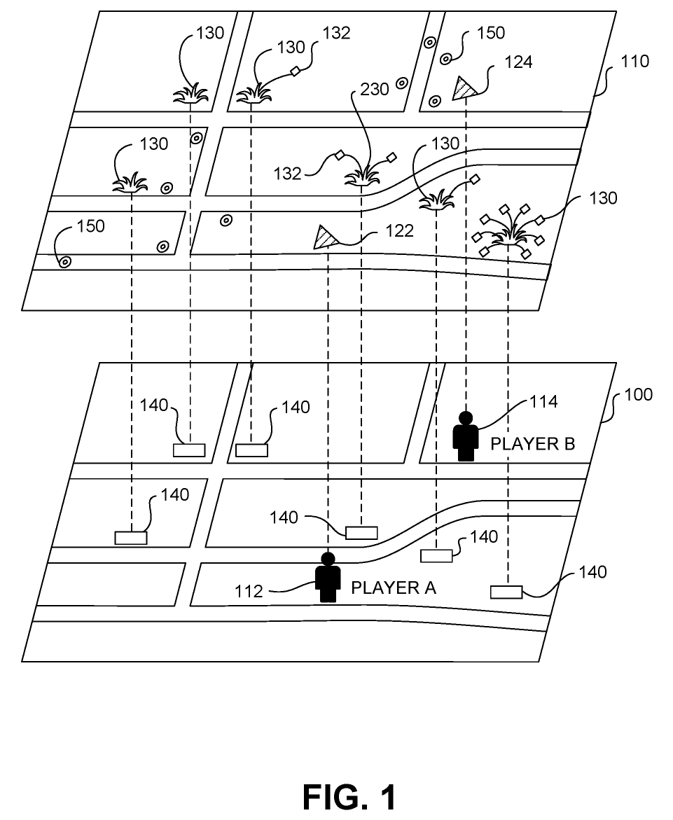

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player’s position in the virtual world 110 corresponds to the player’s position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player’s position as the player navigates the range of geographic coordinates in the real world 100. Data associated with the player’s position in the real world 100 is used to update the player’s position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game’s rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

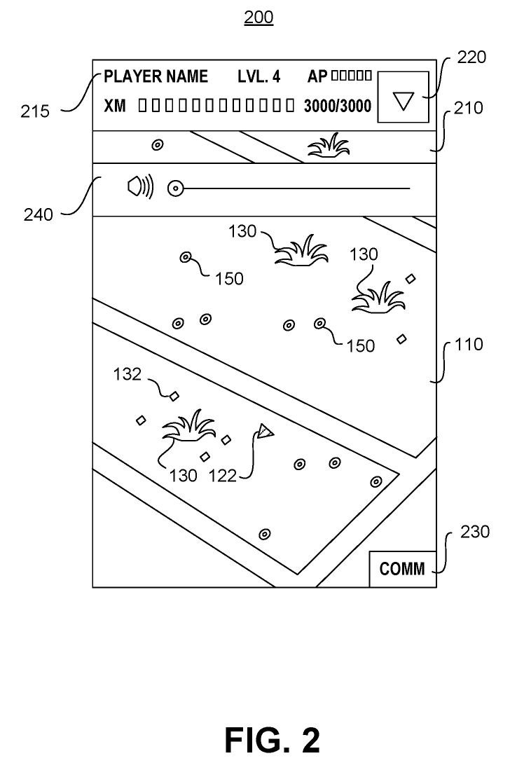

FIG. 2 depicts one embodiment of a game interface 200 that can be presented (e.g., on a player’s smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player’s proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

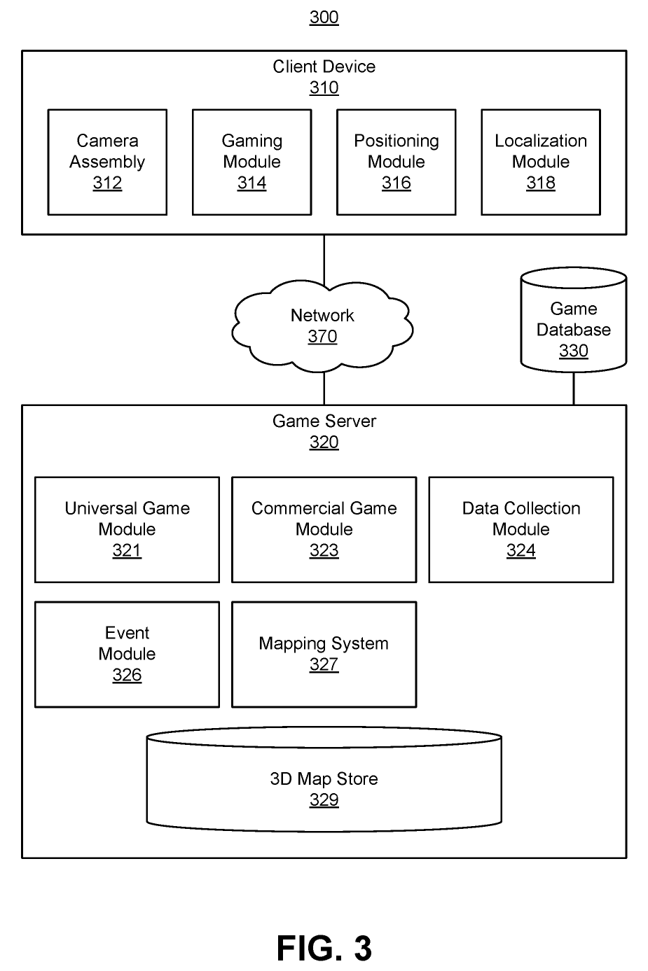

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player’s position in the real world can be tracked and used to update the player’s position in the virtual world. Typically, the player’s position in the real world is determined by finding the location of a client device 310 through which the player is interacting with the virtual world and assuming the player is at the same (or approximately the same) location. For example, in various embodiments, the player may interact with a virtual element if the player’s location in the real world is within a threshold distance (e.g., ten meters, twenty meters, etc.) of the real-world location that corresponds to the virtual location of the virtual element in the virtual world. For convenience, various embodiments are described with reference to “the player’s location” but one of skill in the art will appreciate that such references may refer to the location of the player’s client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, and a localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 321, a commercial game module 323, a data collection module 324, an event module 326, a mapping system 327, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 321 hosts an instance of the parallel reality game for a set of players (e.g., all players of the parallel reality game) and acts as the authoritative source for the current status of the parallel reality game for the set of players. As the host, the universal game module 321 generates game content for presentation to players (e.g., via their respective client devices 310). The universal game module 321 may access the game database 330 to retrieve or store game data when hosting the parallel reality game. The universal game module 321 may also receive game data from client devices 310 (e.g., depth information, player input, player position, player actions, landmark information, etc.) and incorporates the game data received into the overall parallel reality game for the entire set of players of the parallel reality game. The universal game module 321 can also manage the delivery of game data to the client device 310 over the network 370. In some embodiments, the universal game module 321 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 321. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 321. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The mapping system 327 may predict depth from a set of images using robust zero-shot estimation. The mapping system 327 can generalize to multiple domains (e.g., indoors, driving, etc.) of images and can generalize to multiple ranges of depths (e.g., for nearby and distant surfaces). The mapping system’s 327 depth predictions may be consistent across images captured from different viewpoints.

The mapping system 327 receives a set of images captured from multiple viewpoints. The set of images includes a reference image and neighboring images, each associated with a relative pose and intrinsics. In some embodiments, the mapping system 327 selects a reference image from the set or receives a selection of a reference image from a client device 310. The mapping system 327 may extract single view information from the reference image using a reference image encoder.

The mapping system 327 converts each of the set of images into deep feature maps. A deep feature map may be an output of a filter applied to an image of a convolutional neural network (CNN) or visual representation. For example, a feature map may be a two-dimensional array of numbers that highlights specific features in an image, such as edges or textures. The mapping system 327 warps the features maps to the viewpoint of the reference image using a set of hypothesized depth values (i.e. bins). For instance, the mapping system 327 may approximate each depth value by discretizing the depth range into a fixed number of bins, where each bin acts as a hypothesis for the depth value. Each bin may represent an interval of depth values. The mapping system 327 may assign probabilities to each of the bins, and the depth prediction may be a weighted average of the center of the bins, weighted by their assigned probabilities. The mapping system 327 may concatenate the warped features and the deep feature maps with metadata. To determine the metadata’s contribution to the cost volume, the mapping system 327 may, for each image in the set other than the reference image, use metadata from the image and the reference image and predict a score and weight. A weighted sum of the score and weight is used at the value for each position and depth hypothesis in a cost volume. The cost volume is a 3D volume that quantifies the dissimilarity or “cost” between feature points of the images at each hypothesized depth. Put another way, a cost volume that acts as a volumetric representation of how well pixels from the images align with the reference image.

In some implementations, however, the cost volume does not represent a normalized probability distribution, nor does the system compute an explicit probabilistic weighting over depth bins. Instead, the values within the cost volume encode relative likelihoods of depth hypotheses, where higher responses indicate more plausible depth estimates but are not interpreted as true probabilities. The mapping system 327 processes these likelihoods through the subsequent transformer-based prediction stage, which outputs a depth value normalized between 0 and 1. This normalized prediction is then scaled using the previously determined minimum and maximum depth values for the scene, producing a continuous depth estimate without computing a weighted sum of bin centers.

The mapping system 327 selects the depth hypotheses to generalize to any range of depths that may be shown in the images. In particular, the mapping system 327 uses intrinsics and extrinsics from the images to infer minimum and maximum depths that may be matched between the reference image and the images. The mapping system 327 spaces the depth bins within this range. The mapping system 327 determines a minimum and maximum value for an initial depth prediction and uses these values to rebuild the cost volume for the depth prediction.

The mapping system 327 makes the metadata scene scale-agnostic to account for the variety in distance of camera poses to the reference image camera pose. In some embodiments, the mapping system 327 normalizes the relative pose measures of the metadata using a maximum across all of the images in the set and the reference image and normalizes depth hypothesis metadata using the maximum and minimum of the associated deep feature map of the image. The mapping system 327 uses a sigmoid function to determine depth predictions. In particular, the mapping system 327 multiplies the output of the of the sigmoid function by the logarithm of the ratio of the minimum cost volume bin and the maximum cost volume bin and adds the result to the logarithm of the minimum cost volume bin. The mapping system 327 applies an exponential function to the final result to obtain a final depth value.

The mapping system 327 extracts tokens from the reference image and converts the cost volume into a sequence of tokens using a “patchifier.” The patchifier transposes and projects the reference image tokens to obtain deep features at a fraction (e.g., a fourth, an eighth, etc.) of the reference image resolution. The patchifier converts the cost volume into tokens by concatenating deep features from the reference image with the cost volume, which makes down sampling more effective, and flattening the concatenated features into tokens. The down sampling is achieved using strided convolutions. In some embodiments, the mapping system 327 adds the tokens of the cost volume to tokens of the reference image at a fraction (e.g., a sixteenth, etc.) of the reference image resolution. This allows the mapping system 327 to revise and refine the cost volume based on the reference image. The mapping system 327 uses the resulting cost volume as representing depth predictions for the images.

Various embodiments of the process for depth prediction via the mapping system 327 are further described in Appendix A, which is part of this disclosure and specification. Appendix A describes exemplary embodiments, and any features that may be described as or implied to be important, critical, essential, or otherwise required in the Appendix should be understood to only be required in the specific embodiment described and not required in all embodiments.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user’s identity may be treated so that no personally identifiable information can be determined for the user.

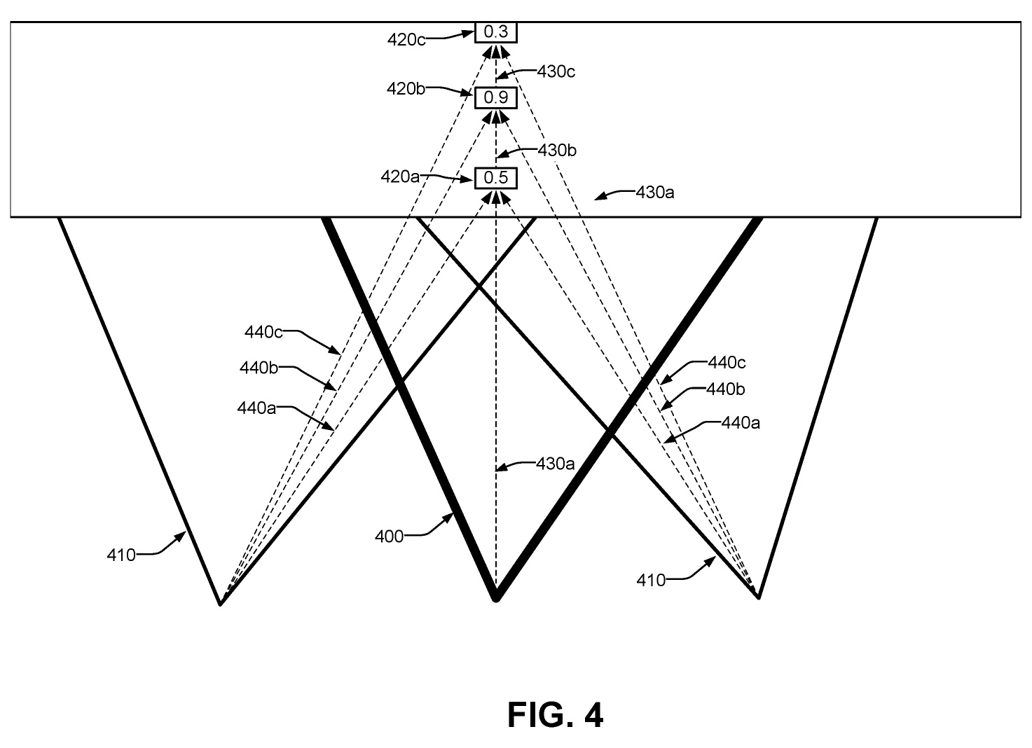

FIG. 4 illustrates an example process for generating cost scores based on deep feature maps, in accordance with some embodiments. FIG. 4 depicts a field of view 400 for the reference image and fields of view 410 for the source images. The computing system can use sensor data describing poses of a camera when it captured each of the images to determine a mapping between the reference frames of the images. For a pixel of the reference image, the system computes a cost score 420 at a set of depths based on feature values 430 from the reference image and feature values 440 the source images. The system uses the mappings of the reference frames to determine how similar the corresponding feature values from the deep feature maps are for the images at each of the depths.

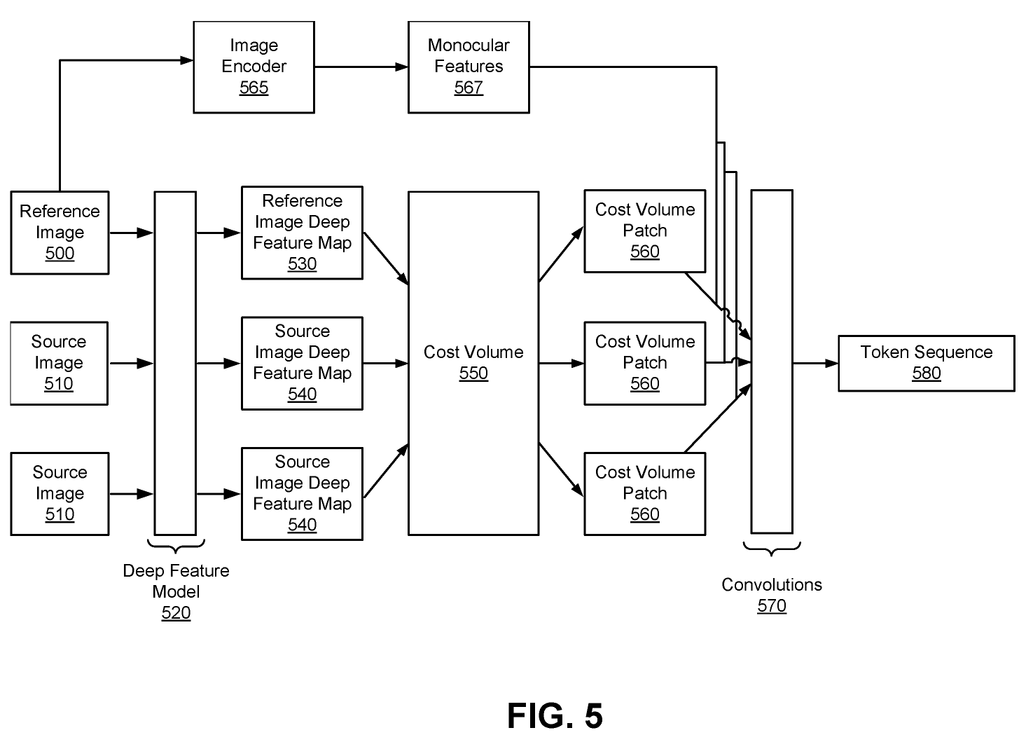

FIG. 5 illustrates an example process for generating a token sequence for input to a transformer model based on a set of source images, in accordance with some embodiments. The system applies a deep feature model 520 to a reference image 500 and source images 510 to generate a deep feature map for the reference image 530 and a deep feature map for the source images 540. The system uses the deep feature maps to generate a cost volume 550. The system generates monocular features 567 by inputting the reference image 500 to an image encoder 565 and concatenates cost volume patches 560, which are portions of the cost volume, with corresponding portions of the monocular features. The system applies convolutions 570 to these concatenations to generate a token sequence 580.

### Example Computing System

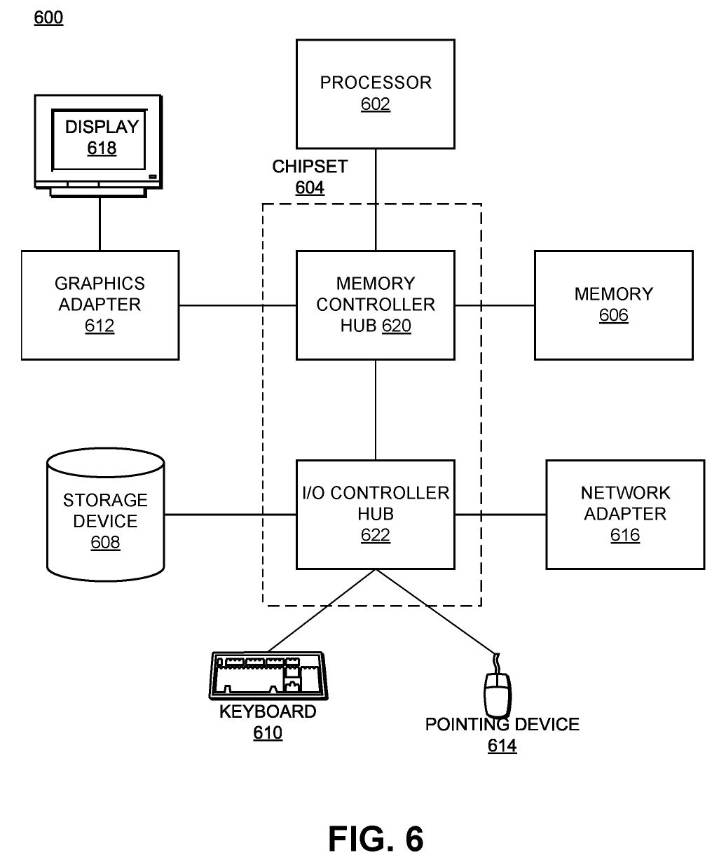

FIG. 6 is a block diagram of an example computer 600 suitable for use as a client device 310 or game server 320. The example computer 600 includes at least one processor 602 coupled to a chipset 604. References to a processor (or any other component of the computer 600) should be understood to refer to any one such component or combination of such components working cooperatively to provide the described functionality. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 4, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 370.

The types of computers used by the entities of FIG. 3 can vary depending upon the embodiment and the processing power required by the entity. For example, the game server 320 might include multiple blade servers working together to provide the functionality described. Furthermore, the computers can lack some of the components described above, such as keyboards 610, graphics adapters 612, and displays 618.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/- 10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
receiving a set of images of an object, wherein each of the set of images is captured with a different field of view, wherein the set of images comprise a reference image and a plurality of source images;
generating a deep feature map for each of the set of images by applying a deep feature model to each of the set of images;
generating a cost volume based on the set of images, wherein generating the cost volume comprises:
mapping the deep feature maps for the plurality of source images to a reference frame of the reference image; and
generating cost scores for the cost volume by comparing corresponding feature values in the deep feature maps of the set of images at different depth values using the reference frame of the reference image;
generating a token sequence by applying a set of convolutions to the cost volume and the deep feature maps;
generating a set of depth values for the object for the reference image by inputting the token sequence into a transformer model; and
storing a depth map for the reference image based on the generated set of depth values.

2. The method of claim 1, wherein the set of images are frames of a video captured by a camera.

3. The method of claim 1, wherein the deep feature model comprises an image encoder model.

4. The method of claim 1, wherein generating the cost volume comprises:
predicting a pose of a camera capturing the set of images using sensor data describing the pose of the camera.

5. The method of claim 1, wherein each cost score for the cost volume is associated with a depth value and a pixel in the reference image, and wherein generating a cost score comprises:
identifying first feature values in the deep feature map for the reference image that correspond to a pixel in the reference image;
identifying second feature values in the deep feature maps for the plurality of source images that correspond to the pixel in the reference image; and
computing a measure of similarity of the first identified feature values and the second feature values.

6. The method of claim 1, wherein generating the cost scores for the cost volume:
selecting a minimum depth value of the object for the reference image;
selecting a maximum depth value of the object for the reference image; and
generating a set of bins based on the minimum depth value and the maximum depth value, wherein each bin corresponds to a distinct range of values between the minimum depth value and the maximum depth value; and
generating cost scores for each of the set of bins.

7. The method of claim 1, wherein the set of bins are linearly spaced between the minimum depth value and the maximum depth value.

8. The method of claim 1, wherein the set of bins are logarithmically spaced between the minimum depth value and the maximum depth value.

9. The method of claim 1, wherein generating the token sequence comprises:
identifying a set of patches of the cost volume;
identifying a corresponding portion of each of the deep feature maps for each of the set of patches;
concatenating each patch with the corresponding portions of the deep feature maps; and
applying the set of convolutions to the concatenations.

10. The method of claim 1, wherein the set of convolutions have a stride that is greater than one.

11. A non-transitory computer-readable medium storing computer-executable instructions that, when executed, cause a computing system to perform operations comprising:
receiving a set of images of an object, wherein each of the set of images is captured with a different field of view, wherein the set of images comprise a reference image and a plurality of source images;
generating a deep feature map for each of the set of images by applying a deep feature model to each of the set of images;
generating a cost volume based on the set of images, wherein generating the cost volume comprises:
mapping the deep feature maps for the plurality of source images to a reference frame of the reference image; and
generating cost scores for the cost volume by comparing corresponding feature values in the deep feature maps of the set of images at different depth values using the reference frame of the reference image;
generating a token sequence by applying a set of convolutions to the cost volume and the deep feature maps;
generating a set of depth values for the object for the reference image by inputting the token sequence into a transformer model; and
storing a depth map for the reference image based on the generated set of depth values.

12. The computer-readable medium of claim 11, wherein the set of images are frames of a video captured by a camera.

13. The computer-readable medium of claim 11, wherein the deep feature model comprises an image encoder model.

14. The computer-readable medium of claim 11, wherein generating the cost volume comprises:
predicting a pose of a camera capturing the set of images using sensor data describing the pose of the camera.

15. The computer-readable medium of claim 11, wherein each cost score for the cost volume is associated with a depth value and a pixel in the reference image, and wherein generating a cost score comprises:
identifying first feature values in the deep feature map for the reference image that correspond to a pixel in the reference image;
identifying second feature values in the deep feature maps for the plurality of source images that correspond to the pixel in the reference image; and
computing a measure of similarity of the first identified feature values and the second feature values.

16. The computer-readable medium of claim 11, wherein generating the cost scores for the cost volume:
selecting a minimum depth value of the object for the reference image;
selecting a maximum depth value of the object for the reference image; and
generating a set of bins based on the minimum depth value and the maximum depth value, wherein each bin corresponds to a distinct range of values between the minimum depth value and the maximum depth value; and
generating cost scores for each of the set of bins.

17. The computer-readable medium of claim 11, wherein the set of bins are linearly spaced between the minimum depth value and the maximum depth value.

18. The computer-readable medium of claim 11, wherein the set of bins are logarithmically spaced between the minimum depth value and the maximum depth value.

19. The computer-readable medium of claim 11, wherein generating the token sequence comprises:
identifying a set of patches of the cost volume;
identifying a corresponding portion of each of the deep feature maps for each of the set of patches;
concatenating each patch with the corresponding portions of the deep feature maps; and
applying the set of convolutions to the concatenations.

20. The computer-readable medium of claim 11, wherein the set of convolutions have a stride that is greater than one.
